(19) United States
(12) Patent Application Publication
(10) Pub. No.: US 2020/0290611 A1
(43) Pub. Date: Sep. 17, 2020

(54) SMOOTH TRANSITION BETWEEN ADAPTIVE CRUISE CONTROL AND CRUISE CONTROL USING VIRTUAL VEHICLE

(71) Applicant: SF Motors, Inc., Santa Clara, CA (US)

(72) Inventors: Yifan Tang, Santa Clara, CA (US); Fan Wang, Santa Clara, CA (US); Rui Guo, Santa Clara, CA (US)

(73) Assignees: SF Motors, Inc., Santa Clara, CA (US); Chongqing Jinkang New Energy Vehicle, Ltd., Chongqing (CN)

(21) Appl. No.: 16/299,143

(22) Filed: Mar. 12, 2019

(51) Int. Cl. B60W 30/14; B60W 50/10

(52) U.S. Cl. CPC B60W 30/143; B60W 50/10; B60W 2720/106; G05D 1/0223; B60W 2540/04; B60W 2540/30; B60W 2550/30

(57) ABSTRACT

An autonomous vehicle with adaptable cruise control in which a virtual vehicle object is generated to pace the autonomous vehicle for a smooth acceleration when transitioning between an ACC mode and a CC mode. An acceleration profile sets a virtual vehicle object acceleration as a function of a speed difference between the current road speed limit and the current autonomous vehicle speed, and the current autonomous vehicle acceleration. The perception data may be generated for the virtual vehicle object to simulate the existence of the virtual vehicle object on the road traveled by the autonomous vehicle. The generated perception data and acceleration data are provided to an ACC module to control the acceleration of the autonomous vehicle. The acceleration profile of the virtual vehicle object is tunable.

### BACKGROUND

Some vehicles in the modern age have cruise control (CC) and adaptive cruise control (ASC C). In CC mode, a vehicle speed is set to a certain number, and a vehicle will consistently accelerate and to maintain that speed regardless of its surroundings. In ACC mode, a vehicle will try to maintain a set speed, but will adjust its speed to the current traffic, such as a closest in path vehicle (CIPV). When a CIPV is detected, the ACC will reduce the speed of the vehicle in order to follow the CIPV at a safe distance, while staying as true to the desired speed as possible while following the CIPV in a safe manner. What is needed is an improved manner for switching between ACC and CC modes.

### SUMMARY

The present technology, roughly described, generates a virtual vehicle object to pace an autonomous vehicle for a smooth acceleration when transitioning between an ACC mode and a CC mode. The virtual vehicle object is associated with computer-generated perception data and an acceleration profile. The acceleration profile sets the virtual vehicle object acceleration as a function of a speed difference between the current road speed limit and the current autonomous vehicle speed, and the current autonomous vehicle acceleration. The perception data may be generated for the virtual vehicle object to simulate the existence of the virtual vehicle object on the road traveled by the autonomous vehicle. The generated perception data and acceleration data are provided to an ACC module to control the acceleration of the autonomous vehicle. In some instances, rather than accelerate at full throttle to attain the speed limit for the currently traveled road, the virtual vehicle object is used to pace the autonomous vehicle's acceleration in order to implement a smooth and varying acceleration over time until the speed limit is reached.

The acceleration profile of the virtual vehicle object is tunable. In some instances, the acceleration profile can have one or more parameters that can be a tuned to achieve a purpose. For example, the parameters may be tuned in response to receiving user input, monitoring user driving activity, or based on other data such as a current weather condition. By tuning the parameters, the acceleration profile may be adjusted to provide an aggressive acceleration, a passive acceleration, acceleration appropriate for weather conditions such as rain or snow, or some other acceleration behavior.

In embodiments, a system for automatically accelerating an autonomous vehicle. The data processing system includes one or more processors, memory, a planning module, and a control module. The data processing system can detect that a first vehicle in a first lane of a road is traveling at a speed below a desired speed for the first vehicle, detect no real objects in front of the first vehicle in the first lane, generate a virtual object having a position in front of the first vehicle in the first lane, the virtual object accelerating in the first lane at a first acceleration rate, and accelerate the first vehicle at a second acceleration rate based at least in part on the position of the virtual position of the first virtual object as the virtual object accelerates in the first lane.

In embodiments, a non-transitory computer readable storage medium includes a program, the program being executable by a processor to perform a method for automatically merging a vehicle from a current lane into a target lane includes a data processing system. The method includes detecting that a first vehicle in a first lane of a road is traveling at a speed below a desired speed for the first vehicle, detecting no real objects in front of the first vehicle in the first lane, generating a virtual object having a position in front of the first vehicle in the first lane, the virtual object accelerating in the first lane at a first acceleration rate, and accelerating the first vehicle at a second acceleration rate based at least in part on the position of the virtual position of the first virtual object as the virtual object accelerates in the first lane.

In embodiments, a method is disclosed for automatically merging a vehicle from a current lane into a target lane includes a data processing system. The method includes detecting that a first vehicle in a first lane of a road is traveling at a speed below a desired speed for the first vehicle, detecting no real objects in front of the first vehicle in the first lane, generating a virtual object having a position in front of the first vehicle in the first lane, the virtual object accelerating in the first lane at a first acceleration rate, and accelerating the first vehicle at a second acceleration rate based at least in part on the position of the virtual position of the first virtual object as the virtual object accelerates in the first lane.

### BRIEF DESCRIPTION OF FIGURES

FIG. 1A illustrates an autonomous vehicle behind an in-path vehicle.

FIG. 1B illustrates an autonomous vehicle with no in path vehicle.

FIG. 1C illustrates an autonomous vehicle with an in-path virtual vehicle object.

FIG. 2 illustrates a block diagram of an autonomous vehicle.

FIG. 3 illustrates a data processing system of an autonomous vehicle.

FIG. 4 illustrates a method for implementing adaptive cruise control with smooth acceleration by an autonomous vehicle.

FIG. 5 illustrates a method for receiving and processing real-world perception data.

FIG. 6 illustrates a method for planning an acceleration action.

FIG. 7 illustrates a method for accelerating an autonomous vehicle.

FIG. 8 illustrates a method for tuning acceleration profile parameters.

FIG. 9a is an illustration of a speed profile over time when transitioning from adaptive cruise control to cruise control for prior systems.

FIG. 9B is an illustration of a speed profile time when transitioning from adaptive cruise control two cruise control using a virtual vehicle object.

FIG. 10 is an illustration of a plot of delta speed versus acceleration.

FIG. 11 is an illustration of a plot of delta speed versus acceleration change rate.

FIG. 12 is an illustration of a plot of speed difference versus virtual vehicle acceleration.

FIG. 13 is a block diagram of a computing environment for implementing the present technology.

### DETAILED DESCRIPTION

The present technology provides a smooth transition from adaptive cruise control mode to cruise control mode by generating a virtual vehicle object to pace an autonomous. The virtual vehicle object is associated with computer-generated perception data and an acceleration profile. The acceleration profile sets the virtual vehicle object acceleration as a function of a speed difference between the current road speed limit and the current autonomous vehicle speed, and the current autonomous vehicle acceleration. The perception data may be generated for the virtual vehicle object to simulate the existence of the virtual vehicle object on the road traveled by the autonomous vehicle. The generated perception data and acceleration data are provided to an ACC module to control the acceleration of the autonomous vehicle. In some instances, rather than accelerate at full throttle to attain the speed limit for the currently traveled road, the virtual vehicle object is used to pace the autonomous vehicle's acceleration in order to implement a smooth and varying acceleration over time until the speed limit is reached.

The acceleration profile of the virtual vehicle object is tunable. In some instances, the acceleration profile can have one or more parameters that can be a tuned to achieve a purpose. For example, the parameters may be tuned in response to receiving user input, monitoring user driving activity, or based on other data such as a current weather condition. By tuning the parameters, the acceleration profile may be adjusted to provide an aggressive acceleration, a passive acceleration, acceleration appropriate for weather conditions such as rain or snow, or some other acceleration behavior.

The present technology addresses a technical problem related to automatically managing acceleration of an autonomous vehicle. Typical cruise control systems, when there is no traffic in the current lane or path of the autonomous vehicle, simply accelerate at a near constant rate until a desired speed is reached. The constant rate acceleration typically provides a jerky, undesirable experience to users of the autonomous vehicle and provides for an uncomfortable ride.

The present technology solves the technical problem of uncomfortable cruise control module acceleration by providing a smooth and tunable acceleration of an autonomous vehicle. The problem is solved by combination of software and hardware, wherein the software creates a virtual vehicle object and accelerates the object according to a tunable acceleration profile. An adaptive cruise control module of the autonomous vehicle can then safely follow the virtual vehicle object until the autonomous vehicle is at a desired speed. Once the autonomous vehicle is at the desired speed, the virtual vehicle object is terminated. The technology is implemented within a computing system, having processors and memory, displaced within and in communication with different portions of an autonomous vehicle.

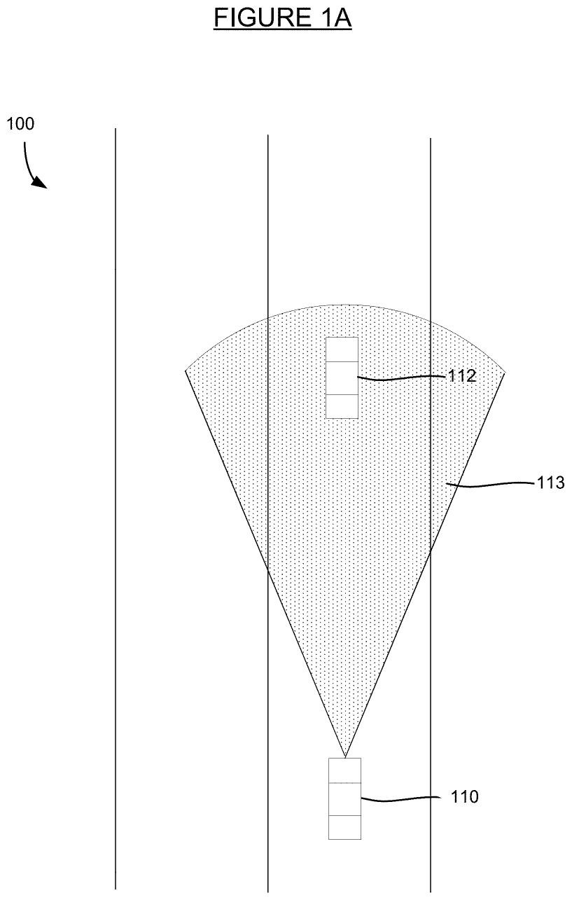

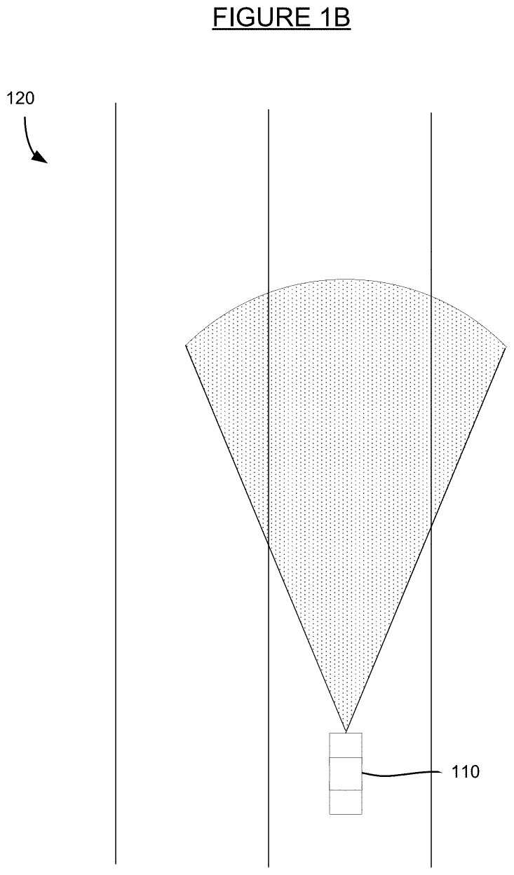

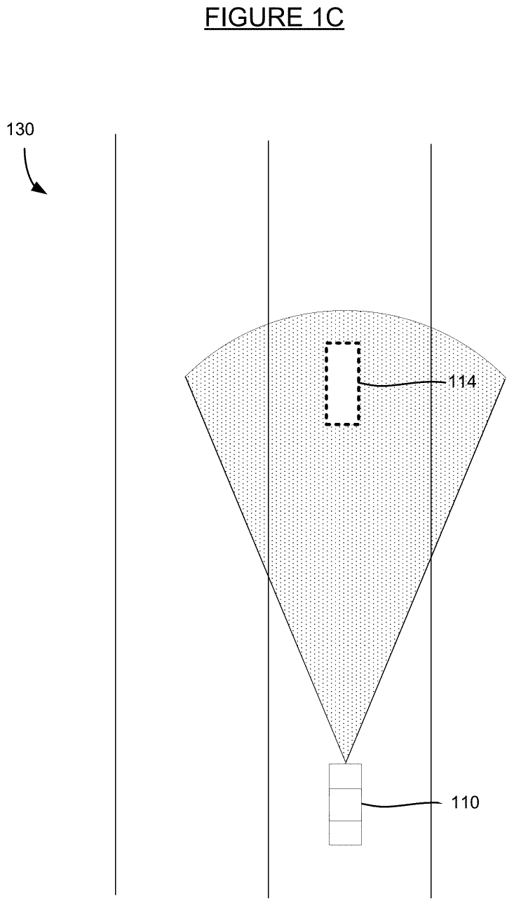

FIG. 1A illustrates an autonomous vehicle behind an in-path vehicle. FIG. 1A includes autonomous vehicle 110 and a closest in path vehicle 112. Sensors on autonomous vehicle 110 detect the presence of vehicle 112 that are within a range 113 of vehicle 110. When an in-path vehicle is detected, autonomous vehicle 110 may utilize adaptive cruise control to attempt to maintain a constant speed. In adaptive cruise control, vehicle 110 can follow in-path vehicle 112 while maintaining the maximum speed possible while maintaining a safe distance from vehicle 112.

FIG. 1B illustrates an autonomous vehicle with no in path vehicles in the current lane. When there is no in path vehicle in front of autonomous vehicle 110 as illustrated in FIG. 1B, autonomous vehicle 110 may accelerate using a cruise control module to attain a desired speed without making any adjustments based on a real vehicle in the path of autonomous vehicle 110. This can result in a jerky or uncomfortable ride to users within autonomous vehicle 110.

FIG. 1C illustrates an autonomous vehicle with a virtual vehicle object in its current lane. The virtual vehicle object 114 is generated with an acceleration profile that guides autonomous vehicle 110 from its current speed to the desired speed of the cruise control unit. Perception data is generated for virtual vehicle object 114 and provided to adaptive cruise control module along with an acceleration profile. The generated perception data and acceleration profile are used to control the acceleration of autonomous vehicle 110 as if it were behind a real vehicle in the current lane.

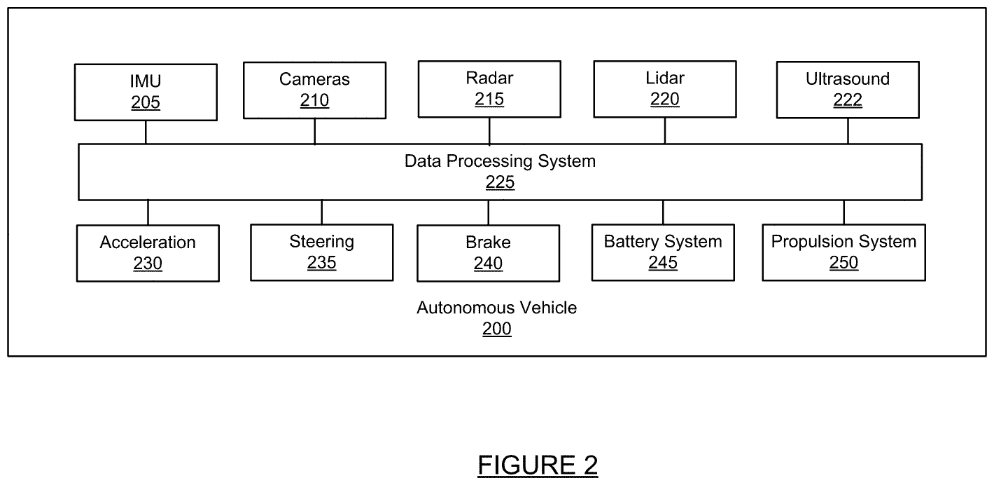

FIG. 2 illustrates a block diagram of an autonomous vehicle. The AV 210 of FIG. 2 includes a data processing system 225 in communication with an inertia measurement unit (IMU) 105, cameras 210, radar 215, lidar 220, and ultrasound sensor 222. Data processing system 225 may also communicate with acceleration 230, steering 235, breaks 240, battery system 245, and propulsion system 250. The data processing system and the components to communicate with are intended to be exemplary for purposes of discussion. It is not intended to be limiting, and additional elements of an AV may be implemented in a system of the present technology, as will be understood by those of ordinary skill in the art.

IMU 205 may track and measure the AV acceleration, yaw rate, and other measurements and provide that data to data processing system 225.

Cameras 210, radar 215, lidar 220, and ultrasound 222 may form all or part of a perception component of AV 210. The AV may include one or more cameras 210 to capture visual data inside and outside of the AV. On the outside of the AV, multiple cameras may be implemented. For example, cameras on the outside of the vehicle may capture a forward-facing view, a rear facing view, and optionally other views. Images from the cameras may be processed to detect objects such as streetlights, stop signs, lines or borders of one or more lanes of a road, vehicles, and other aspects of the environment. To detect the objects, pixels of images are processed to recognize objects in singular images and series of images. The processing may be performed by image and video detection algorithms, machine learning models which are trained to detect particular objects of interest, neural networks, and other techniques.

Radar 215 may include multiple radar sensing systems and devices to detect objects around the AV. In some instances, a radar system may be implemented at one or more of each of the four corners of the vehicle, a front of the vehicle, a rear of the vehicle, and on the left side and right side of the vehicle. The radar elements may be used to detect stationary and moving objects in adjacent lanes as well as in the current lane in front of and behind the AV, such as for example an in-path vehicle. Lidar may also be used to detect objects in adjacent lanes, as well as in front of and behind the current vehicle.

Ultrasound 222 may include one or more ultrasound sensors that detect the presence of objects in the vicinity of the AV. The ultrasound sensors can be positioned at one or more locations around the perimeter of the car to detect stationary and moving objects.

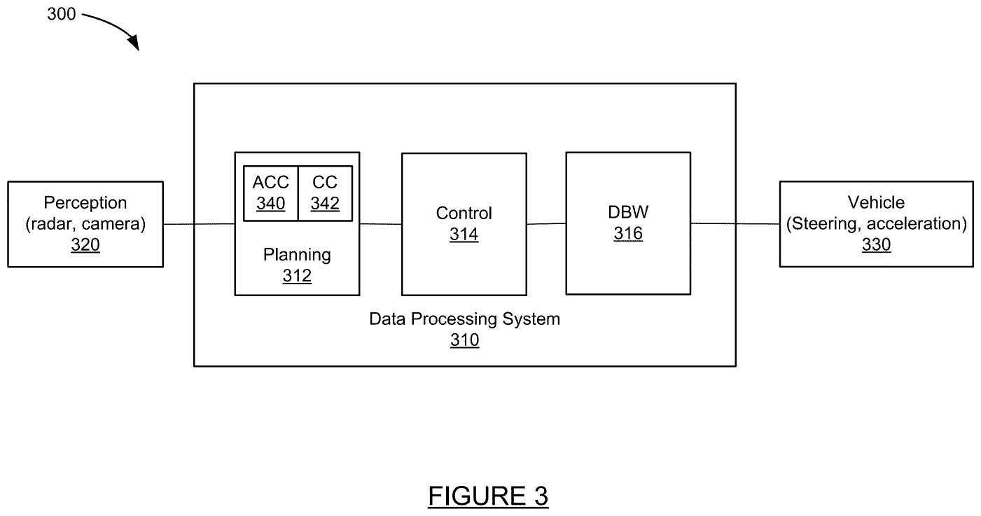

Data processing system 225 may include one or more processors, memory, and instructions stored in memory and executable by the one or more processors to perform the functionality described herein. In some instances, the data processing system may include a planning module, a control module, and a drive-by wire module. The modules communicate with each other to receive data from a perception component plan actions such as lane changes, and generate commands to execute lane changes. The data processing system 225 is discussed in more detail below with respect to the system of FIG. 3.

Acceleration 230 may receive commands from the data processing system to accelerate the AV. Acceleration 230 may be implemented as one or more mechanisms to apply acceleration to the propulsion system 250. Steering module 235 controls the steering of the AV, and may receive commands to steer the AV from data processing system 235. Brake system 240 may handle braking applied to the wheels of AV 210, and may receive commands from data processing system 225.

Battery system 245 may include a battery, charging control, battery management system, and other modules and components related to a battery system on an AV. Propulsion system 250 may manage and control propulsion of the vehicle, and may include components of one or more combustion engines, electric motors, drivetrains, and other components of a propulsion system utilizing an electric motor with or without a combustion engine.

FIG. 3 illustrates a data processing system. Data processing system 310 provides more detail for data processing system 225 of the system of FIG. 2. Data processing system may receive data and information from perception components 320. Perception component 220 may include camera, radar, lidar, and ultrasound elements, as well as logic for processing the output captured by each element to identify objects of interest, including but not limited to vehicle objects, lane lines, and other environment elements. Perception 320 may provide a list of objects, lane detection data, and other data to planning module 312.

Planning module 312 may receive and process data and information received from the perception component to plan actions for the AV. The actions may include following an in-path vehicle while trying to attain a desired speed, accelerating and decelerating, slowing down and/or stopping before an in-path virtual object, stopping, accelerating, turning, and performing other actions. Planning module 312 may generate samples of trajectories between two lines or points, analyze and select the best trajectory, and provide a best trajectory for navigating from one point to another to control module 314.

Planning module 312 includes adaptive cruise control module 340 and cruise control module 342. In CC mode, a vehicle speed is set to a certain number, and the vehicle will consistently accelerate and decelerate to maintain that speed. In ACC mode, a vehicle speed will adjust to the current traffic, such as a closest in path vehicle (CIPV). Planning module 312 may generate perception data and an acceleration profile and provide the data and profile to ACC module 340. In some instances, ACC 340 and CC 342 may be implemented as logically the same or separate modules, or may including overlapping logical portions.

Control module 314 may receive information from the planning module, such as a selected acceleration plan. Control module 314 may generate commands to be executed in order to navigate the selected trajectory. The commands may include instructions for accelerating, breaking, and turning to effectuate navigation along the best trajectory.

Drive-by wire module 316 may receive the commands from control module 316 and actuate the AV navigation components based on the commands. In particular, drive-by wire 316 may control the accelerator, steering wheel, brakes, and turn signals of the AV.

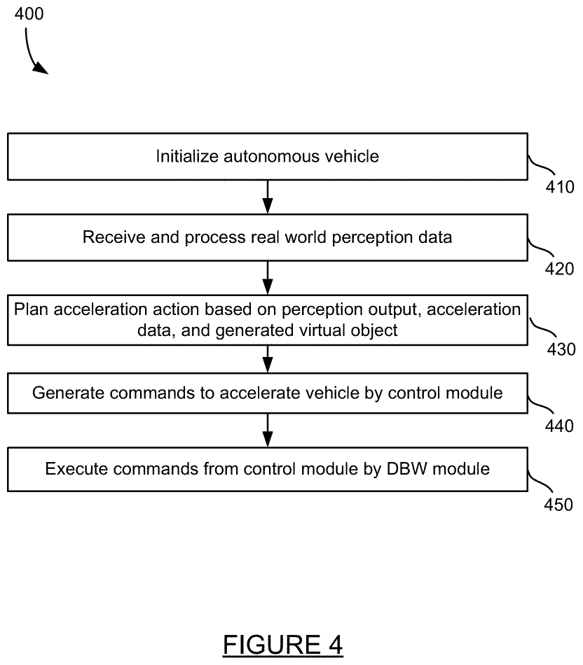

FIG. 4 illustrates a method for implementing adaptive cruise control with smooth acceleration by an autonomous vehicle. An autonomous vehicle is initialized at step 410. Initialization may include performing diagnostics, warming up systems, doing a system check, calibrating vehicle systems and elements, and performing other operations associated with checking the status of an autonomous vehicle at startup.

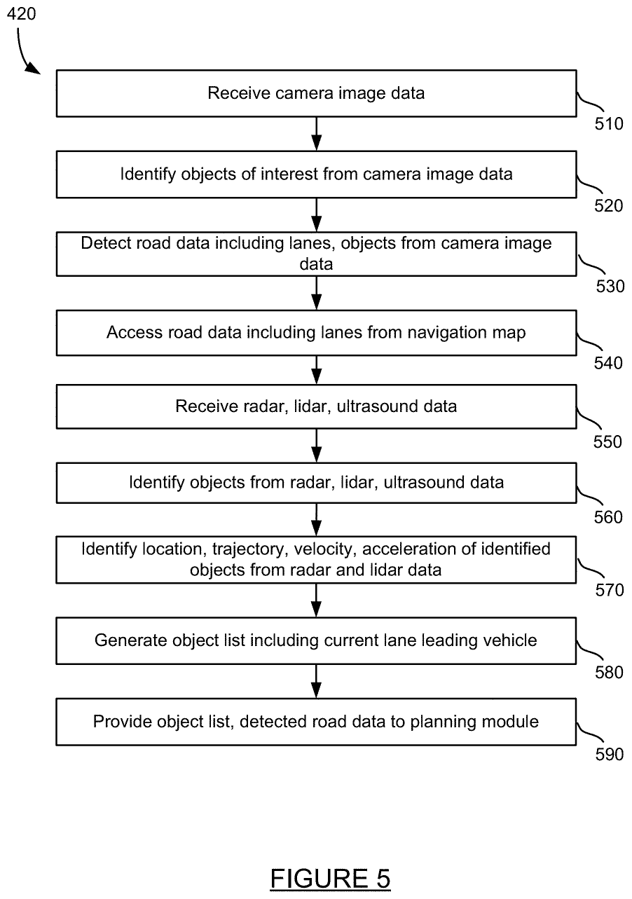

Real-world perception data is received and processed at step 420. The perception data received and processed at step 420 is associated with existing physical objects or elements in a real environment, such as vehicles, road lanes, and other elements. The data may be processed to provide road information and an object list by logic associated with the perception component. The road information and object list are then provided to a planning module of the data processing system. In some instances, receiving and processing perception data is performed on an ongoing basis, and timing of step 420 in the method of FIG. 4 is for purposes of discussion only. More detail for receiving and processing real-world perception data is discussed with respect to the method of FIG. 5.

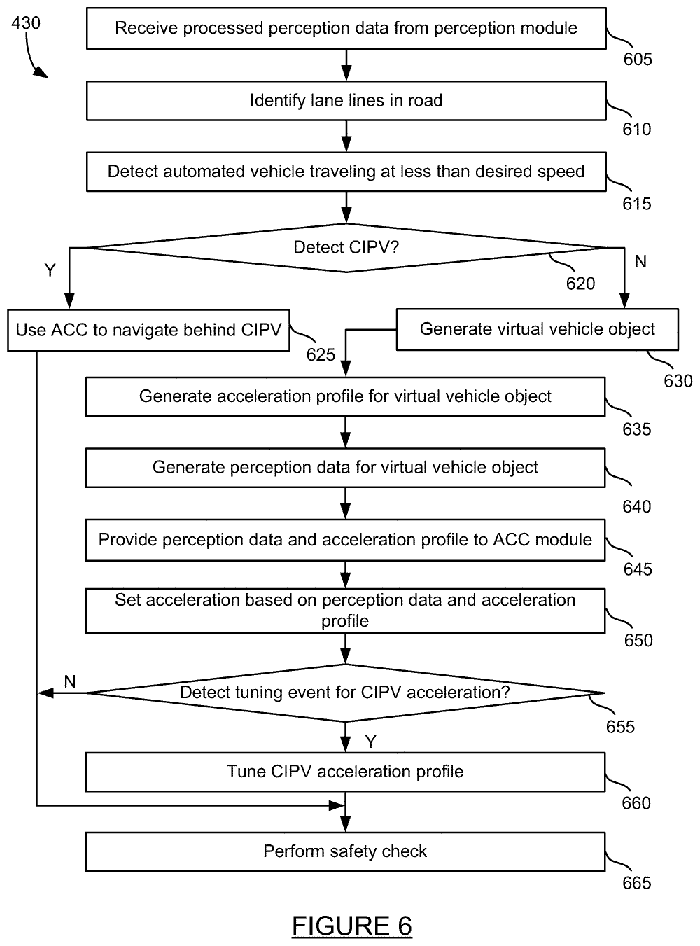

An acceleration action is planned based on the perception output, acceleration data, and generated virtual object at step 430. Planning the acceleration action may include generating a virtual vehicle object, generating acceleration profile for the object, and determining the acceleration for an autonomous vehicle that follows the virtual vehicle object. More details for planning and acceleration action are discussed with respect to the method of FIG. 6.

Commands are generated to accelerate the autonomous vehicle by a control module at step 440. The commands may be generated in response to the planned acceleration action of step 430. The commands may relate to apply acceleration to an accelerator applying brakes, using turn signals, turning a steering wheel, and performing other actions that result in navigation of the autonomous vehicle.

The generated commands are executed by the drive-by wire module at step 450. The drive-by wire module may be considered an actuator, which receives the generated commands to accelerate the vehicle and executes them on vehicle systems.

FIG. 5 illustrates a method for receiving and processing real-world perception data. The method of FIG. 5 provides more detail for step 420 of the method of FIG. 4. The method of FIG. 5 provides more detail for step 420 of the method of FIG. 4. First, camera image data is received at step 510. The camera image data may include images and/or video of the environment through which the AV is traveling. Objects of interest may be identified from the camera image and/or video data at step 520. Objects of interest may include a stop light, stop sign, other signs, vehicles, and other objects of interest that can be recognized and processed by the data processing system. In some instances, image data may be processed using pixel clustering algorithms to recognize certain objects. In some instances, pixel data may be processed by one or more machine learning models are trained to recognize objects within images, such as vehicles, traffic light objects, stop sign objects, other sign objects, road lane lines, and other objects of interest.

Road lanes are detected from the camera image data at step 530. Road lane detection may include identifying the boundaries of a particular road, path, or other throughway. The road boundaries and lane lines may be detected using pixel clustering algorithms to recognize certain objects, one or more machine learning models trained to recognize road boundary and lane objects within images, or by other object detection methods.

Road data including road lanes and other road data may be accessed from a navigation map at step 540. The navigation map may be accessed locally from memory or remotely via one or more wired or wireless networks.

Radar, lidar, and ultrasound data are received at step 550, and the received data may be processed to identify objects within the vicinity of the AV, such as between zero and several hundred feet of the AV at step 560. The processed radar, lidar, and ultrasound data may indicate the speed, trajectory, velocity, and location of an object within the range of sensors on the AV (step 570). Examples of objects detectable by radar, lidar, and ultrasound include cars, trucks, people, and animals.

An object list of the objects detected via radar, lidar, ultrasound, and objects of interest from the camera image data is generated at step 580. For each object in the list, information may be included such as an identifier for the object, a classification of the object, location, trajectory, velocity, acceleration of the object, and in some instances other data. In some instances, the object list can include any in-path vehicles traveling at the same speed as the autonomous vehicle. The object list, road boundaries, lane merge data, and detected lanes is provided to a planning module at step 590.

FIG. 6 illustrates a method for planning an acceleration action. The method of FIG. 6 provides more detail for step 430 of the method of FIG. 4. Processed perception data is received from the perception module at step 605. The processed perception data may include an object list, lane line detection data, and other content. Lane lines in a road traveled by the autonomous vehicle identified from the received process perception data at step 610. A detection is made that the present autonomous vehicle is currently traveling at less than a desired speed at step 615. The autonomous vehicle may be traveling at less than the speed limit due to following an in-path vehicle that has recently changed lanes or just starting the cruise control process.

A determination is made as to whether a closest in path vehicle was detected from the received process perception data at step 620. If another vehicle is in the path of the automated vehicle, the adaptive cruise control may be used to navigate the autonomous vehicle behind the detected in-path vehicle at step 625. The method of FIG. 6 then continues to step 665. If a closest in-path vehicle is not detected at step 620, a virtual vehicle object is generated at step 630. The virtual vehicle object may be generated with a position, acceleration, and location, and may include data similar to that for each object in the object list received from a perception data module. In particular, the object may be identified as a vehicle, and associated with the location and other data.

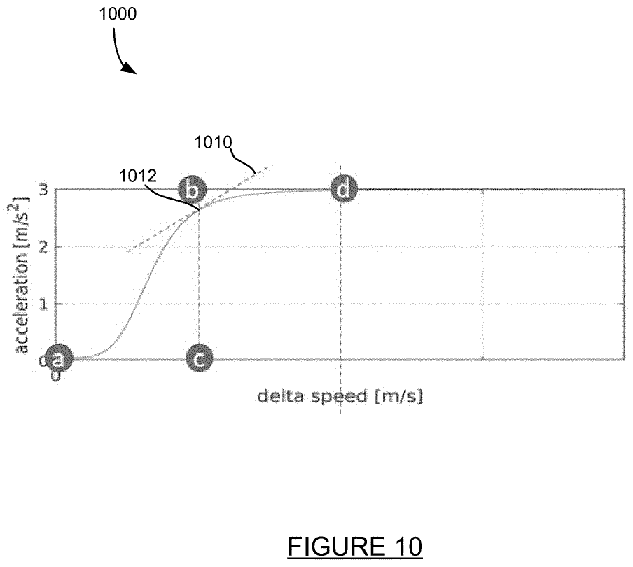

After generating a virtual vehicle object, an acceleration profile is generated for the virtual vehicle object at step 635. Generating an acceleration profile may include initiating a function having a number of tunable parameters that configure the acceleration. In some instances, an acceleration profile can be a four-parameter logistic (4PL) symmetrical model having a general form as follows:

$$y = d + \frac{a - d}{1 + {( \frac{x}{c} )}^{b}} \qquad Eqn . 1$$

wherein x is the speed difference between the road speed limit and the current vehicle speed (as “delta speed” in FIG. 10), a is the final acceleration value for the virtual vehicle object (e.g., zero), d is the current vehicle acceleration, c is the point of inflection 1012 in FIG. 10 (i.e. the point on the S shaped curve of FIG. 10 halfway between a and d), and b is the slope 1010 of the curve (i.e. this is related to the steepness of the curve at point c).

The parameters of the acceleration profile of equation 1 can be tuned to effectuate different acceleration behaviors. For example, the smaller the value for b, the smoother the transition would occur.

Perception data for the virtual vehicle object is generated at step 640. Generating the perception data may include generating data typically associated with an object in an object list, such as an object type classification, location, velocity, and other data.

Perception data and the acceleration profile are provided to the adaptive cruise control module at step 645. The generated perception data appears no different to the adaptive cruise control module than data received externally from the perception module.

Acceleration for the autonomous vehicle is set based on the virtual vehicle object perception data and acceleration profile step 650. Acceleration of the virtual vehicle object may be based on any of several acceleration profiles, such as for example the acceleration profile of equation 1.

Once acceleration of the virtual vehicle object is set, the acceleration of the autonomous vehicle may automatically be set to the maximum speed that allows for following the virtual vehicle object at a safe distance. As a virtual vehicle object accelerates in a smooth manner from the current speed of the autonomous vehicle to the maximum desired speed, the autonomous vehicle will follow the virtual vehicle object in a smooth manner. In some instances, the perception data generated for the virtual vehicle object will include sensor data that indicates a vocation, velocity, and acceleration of the virtual vehicle object. With this information, the ACC module can set the autonomous vehicle speed and acceleration in order to follow the virtual vehicle object at a safe distance while still maximizing the speed of the autonomous vehicle. Any of several methodologies may be used to configure the autonomous vehicle to follow the virtual vehicle object. Examples of such following behavior are described in “A behavior Car-Following Model for Computer Simulation,” by P. G. Gipps, CSIRO Division of Building Research, and “Cooperative Adaptive Cruise Control: An Artificial potential field Approach,” by Semsa-Kazerooni, Verhaegh, Ploeg, and Alirezaei.

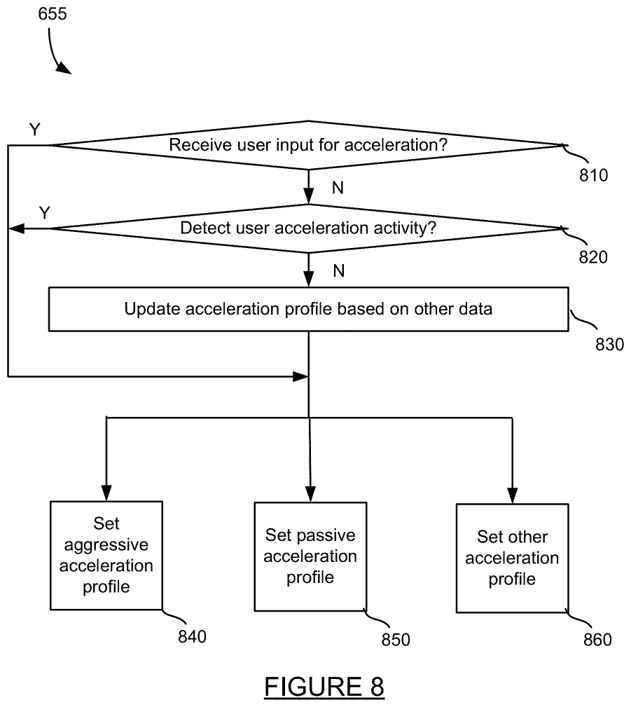

A determination is made as to whether a tuning event is detected for the closest in path vehicle acceleration at step 655. The tuning event may be triggered by receiving user input, detecting user activity, or other data such as the current weather. If no tuning event is detected, the method continues to step 665. If a tuning event is detected, the closest in path vehicle acceleration profile is updated or tuned at step 660 tuning the CIP be acceleration profile is discussed in more detail with respect to the method of FIG. 8. After tuning the acceleration profile, the method of FIG. 6 continues to step 665.

A safety check is performed at step 665. The safety check confirms that the acceleration profile been implemented by the ACC is safe. A safety check may include confirming all obstacles exist along the selected trajectory, no collisions will occur along the selected trajectory, and that the AV can physically navigate along the selected trajectory. The data processing system can confirm that the objects in the object list are not positioned in the trajectory as well as any new objects detected by radar, lidar, or camera data. Collisions may be detected to occur if an unexpected curvature in the road occurs, an unexpected boundary within a road is detected, or some other unforeseen obstacle appears in the selected trajectory

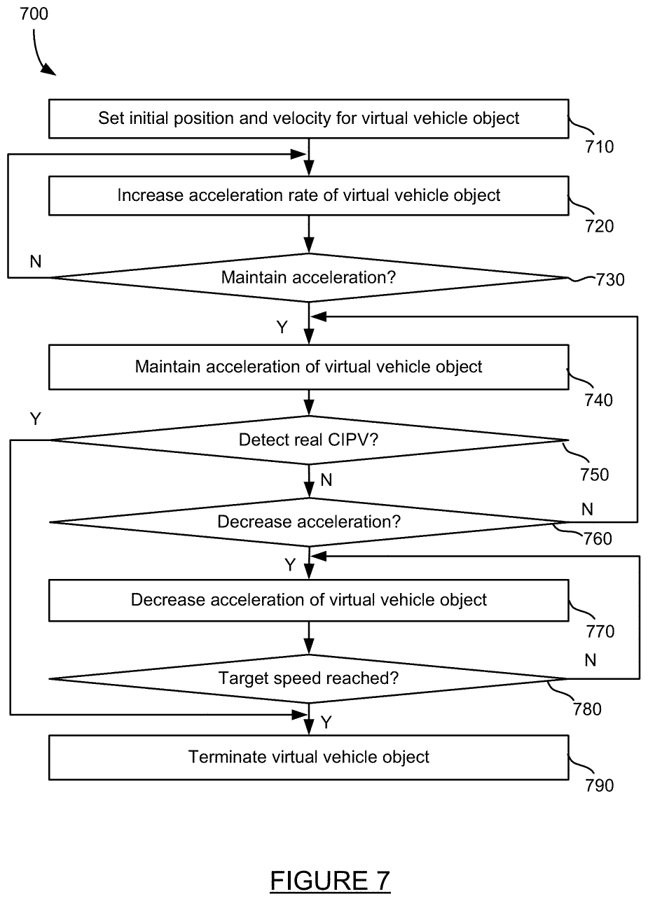

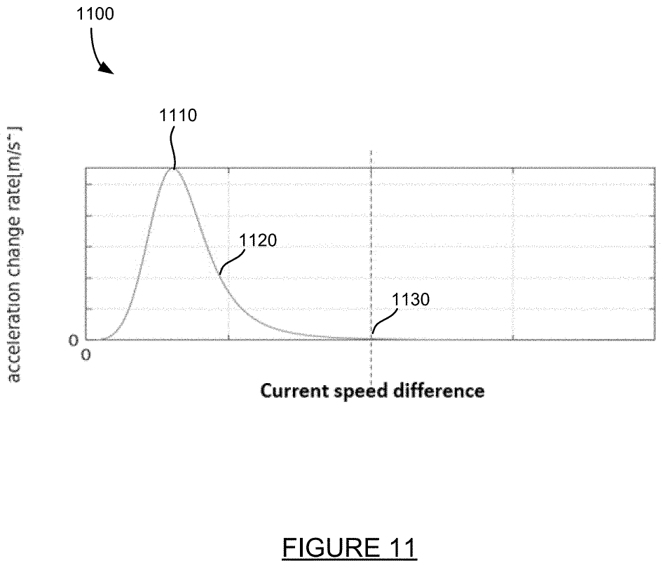

FIG. 7 illustrates a method for accelerating an autonomous vehicle. To implement a smooth acceleration profile for the virtual vehicle object, the acceleration of the virtual vehicle object will change over time while increasing speed from a current speed to a desired speed. The acceleration change rate of the function of the delta speed is illustrated in FIG. 11. As shown in FIG. 11, as the change in speed decreases from 10 to 3, the acceleration change rate increases. After reaching a peak at a delta speed of three, the acceleration change rate decreases until it reaches zero when there is no change in speed between the virtual vehicle object and a desired speed.

Returning to FIG. 7, an initial position and velocity is set for the virtual vehicle object at step 710. The acceleration rate of the virtual vehicle object is increased at step 720. This corresponds to the initial increase in FIG. 11 between a Delta speed of 10 and five. A determination is made as to whether the acceleration rate of the virtual vehicle object should be maintained at step 730. If the acceleration rate should be increased, and the method returns to step 720. If the current acceleration rate should be maintained without further increases, acceleration of the virtual vehicle object is maintained at step 740. A determination is then made as to whether a real closest in path vehicle is detected in the same lane as the autonomous vehicle at step 750. If a vehicle is detected during the process of FIG. 7, the virtual vehicle object is terminated, and the adaptive cruise control sets the autonomous vehicle speed and acceleration based on the detected CIP be. If no CIP be is detected, the method of FIG. 7 continues to step 760.

In some instances, the virtual vehicle object is terminated whenever a CIP be is detected. The CIP be detection may occur at step 750 in the method of FIG. 7, or at any other location during the method of FIG. 7. For example, the CIP be may be detected as soon as acceleration rate of the virtual vehicle object is increased at step 720.

A determination is made as to whether acceleration should be decreased at step 760. After the acceleration rate attains peak 1110 is shown in FIG. 11, the acceleration rate will start to decrease. If the peak is not yet reached and acceleration profile, the method of FIG. 7 returns to step 740. If the acceleration is to be decreased, the acceleration is decrease for the virtual vehicle object at step 770. A determination is then made as to whether a target speed is reached for the virtual vehicle object at step 780. If the target speed is reached, then the autonomous vehicle has been brought up to the desired speed and there is no longer a need for the virtual vehicle object. If the target speed is not been reached, the method continues to step 770. If the target speed is reached, the virtual vehicle object is terminated at step 790.

FIG. 8 is a method for tuning acceleration profile parameters. The method of FIG. 8 provides more detail for step 655 of the method of FIG. 6. A determination is made as for the user input is received regarding a desired acceleration profile at step 810. User input may be a request for tuning and acceleration profile for aggressive the acceleration, passive acceleration, or some other acceleration profile. If no user input is received, the method FIG. 8 continues to step 820. If user input is received to modify the acceleration profile, the solution profiles modified in the appropriate way at step 840, 850 or 860.

A determination is made as to whether acceleration profile should be tuned in response to detecting user acceleration activity at step a 20. In some instances, the driving habits of a user may be monitored, in particular the acceleration habits. If a user accelerates in a slow, passive matter, then and acceleration profile for a virtual vehicle object can be tuned to have a passive acceleration profile at step 850. If a user typically accelerates in an aggressive manner when there are no cars in front of a vehicle, then the acceleration profile for the virtual vehicle object may be set to an aggressive profile at step 840. If the user has acceleration habits other than being described as passive or aggressive, the appropriate acceleration profile may be set at step 860 based on the user's habits. If no user acceleration activities detected at step a 20, the acceleration profile maybe tuned based on other data at step 830. For example, if the autonomous vehicle the text that the roads are currently wet, the acceleration profile may be set to a passive acceleration profile is safe 850 to avoid sliding and on a slippery road.

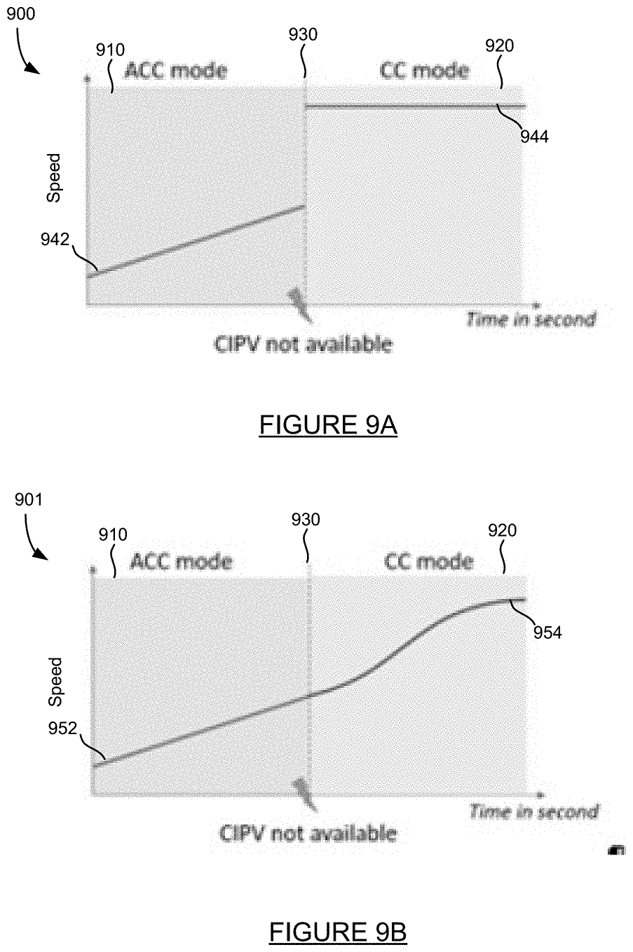

FIG. 9A is an illustration of a speed profile over time when transitioning from adaptive cruise control to cruise control for prior systems. In typical vehicles, the acceleration implemented while a car is an ACC mode and following another vehicle is typically a gradual increase as shown by line 942. If the vehicle in the path of the autonomous vehicle leaves the current lane, the typical acceleration of the autonomous vehicle increases rapidly and uncomfortably to the maximum allowable speed, as illustrated by the transition at point 930 between the speed of portion 910 and the speed at portion 920 of FIG. 9A and current speed 944.

FIG. 9B is an illustration of a speed profile time when transitioning from adaptive cruise control to cruise control using a virtual vehicle object. When an autonomous vehicle is following another vehicle in the current lane, the ACC mode handles vehicle acceleration, and the speed profile may be similar to that of FIG. 9A. When the current in-path vehicle leaves the current lane, and a virtual vehicle object is generated to provide smooth acceleration for the autonomous vehicle, the speed profile 954 of the vehicle attaining the maximum speed by following and accelerating virtual vehicle object is much smoother than line 944 FIG. 9A.

FIG. 10 is an illustration of a plot of delta speed versus acceleration. Illustration 1000 of FIG. 10 shows the acceleration profile of the virtual vehicle object. When the CIPV is not available, the speed difference between the road speed limit and the current vehicle speed is at its maximum value at point d. At this moment, the virtual vehicle would have the exact same acceleration as the autonomous vehicle. As the speed is approaching the target speed, the delta speed would go to zero along the smooth profile. At the end, the speed of the virtual vehicle would travel at the target speed. FIG. 11 is an illustration of a plot of current speed distance versus acceleration change rate. FIG. 11 illustrates that the rate of acceleration changes smoothly the entire time between when the CIPV disappears and the current vehicle reaches the speed limit, which guarantees a smooth transition. The point 1110 at which the speed difference is maximum corresponds to point b in the plot of FIG. 10, while point 1130 corresponds to point d in the plot of FIG. 10.

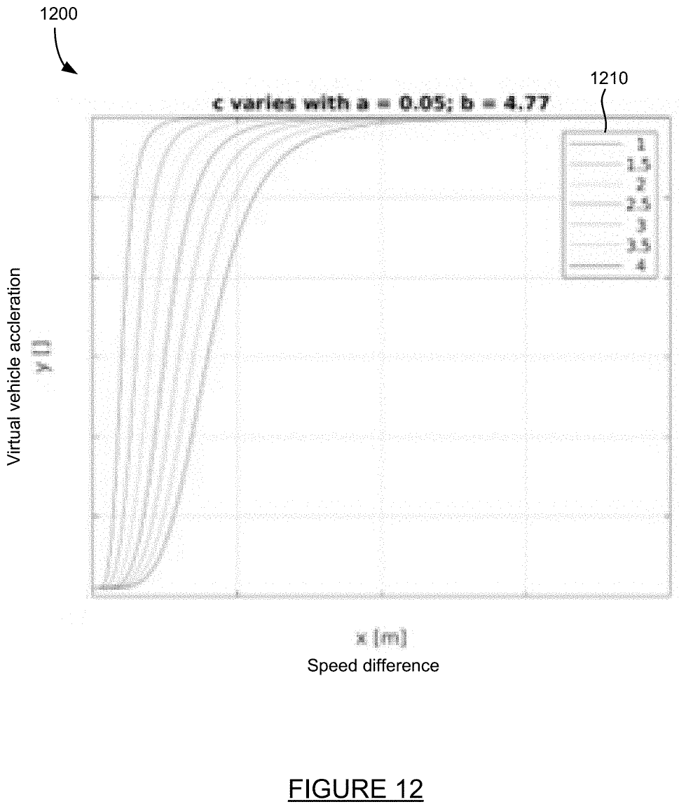

FIG. 12 is an illustration of a plot of speed difference versus virtual vehicle acceleration. The image includes several plots associated with acceleration profiles having a set value for a (0.05) and a set value for b (4.77). For each of the seven plots, the value of c differs from a range of 1 to 4. The smaller the b value in the plots of FIG. 12, the smoother the transition would happen

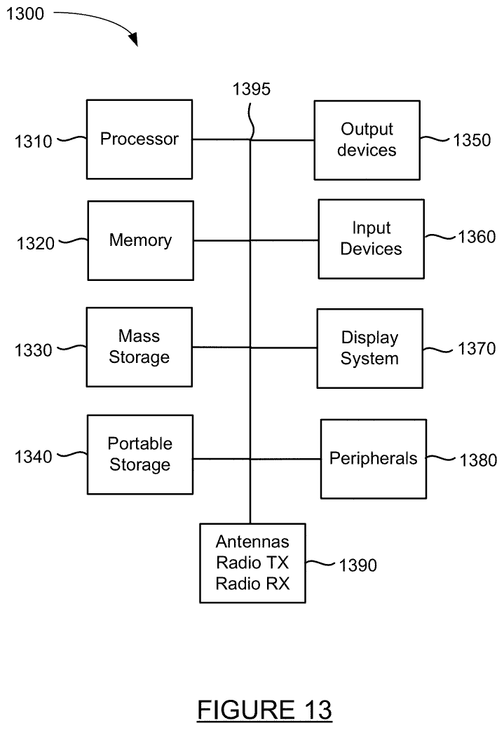

FIG. 13 is a block diagram of a computing environment for implementing a data processing system. System 1300 of FIG. 13 may be implemented in the contexts a machine that implements data processing system 125 on an AV. The computing system 1300 of FIG. 13 includes one or more processors 1310 and memory 1320. Main memory 1320 stores, in part, instructions and data for execution by processor 1310. Main memory 1320 can store the executable code when in operation. The system 1300 of FIG. 13 further includes a mass storage device 1330, portable storage medium drive(s) 1340, output devices 1350, user input devices 1360, a graphics display 1370, and peripheral devices 1380.

The components shown in FIG. 13 are depicted as being connected via a single bus 1390. However, the components may be connected through one or more data transport means. For example, processor unit 1310 and main memory 1320 may be connected via a local microprocessor bus, and the mass storage device 1330, peripheral device(s) 1380, portable storage device 1340, and display system 1370 may be connected via one or more input/output (I/O) buses.

Mass storage device 1330, which may be implemented with a magnetic disk drive, an optical disk drive, a flash drive, or other device, is a non-volatile storage device for storing data and instructions for use by processor unit 1310. Mass storage device 1330 can store the system software for implementing embodiments of the present technology for purposes of loading that software into main memory 1320.

Portable storage device 1340 operates in conjunction with a portable non-volatile storage medium, such as a flash drive, USB drive, memory card or stick, or other portable or removable memory, to input and output data and code to and from the computer system 1300 of FIG. 13. The system software for implementing embodiments of the present technology may be stored on such a portable medium and input to the computer system 1300 via the portable storage device 1340.

Input devices 1360 provide a portion of a user interface. Input devices 1360 may include an alpha-numeric keypad, such as a keyboard, for inputting alpha-numeric and other information, a pointing device such as a mouse, a trackball, stylus, cursor direction keys, microphone, touch-screen, accelerometer, wireless device connected via radio frequency, motion sensing device, and other input devices. Additionally, the system 1300 as shown in FIG. 13 includes output devices 1350. Examples of suitable output devices include speakers, printers, network interfaces, speakers, and monitors.

Display system 1370 may include a liquid crystal display (LCD) or other suitable display device. Display system 1370 receives textual and graphical information and processes the information for output to the display device. Display system 1370 may also receive input as a touch-screen.

Peripherals 1380 may include any type of computer support device to add additional functionality to the computer system. For example, peripheral device(s) 1380 may include a modem or a router, printer, and other device.

The system of 1300 may also include, in some implementations, antennas, radio transmitters and radio receivers 1390. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1300 of FIG. 13 are those typically found in computer systems that may be suitable for use with embodiments of the present invention and are intended to represent a broad category of such computer components that are well known in the art. Thus, the computer system 1300 of FIG. 13 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A system for automatically accelerating an autonomous vehicle, comprising:
a data processing system comprising one or more processors, memory, a planning module, and a control module, the data processing system to:
detecting that a first vehicle in a first lane of a road is traveling at a speed below a desired speed for the first vehicle;
detecting no real objects in front of the first vehicle in the first lane;
generating a virtual object having a position in front of the first vehicle in the first lane, the virtual object accelerating in the first lane at a first acceleration rate; and
accelerating the first vehicle at a second acceleration rate based at least in part on the position of the virtual position of the first virtual object as the virtual object accelerates in the first lane.

2. The system of claim 1, wherein the acceleration of the virtual object is tunable.

3. The system of claim 2, wherein the acceleration is tunable based on user input, user driving data, or other data.

4. The system of claim 2, wherein the acceleration is tunable based on the acceleration of the first vehicle, the speed difference between the first vehicle current speed and the desired speed,

5. The system of claim 1, wherein accelerating the first vehicle includes:
providing perception data for the generated virtual object to an adaptive cruise control system, the perception data including location and acceleration data; and
initiating control of the first vehicle by the adaptive cruise control system to accelerate towards the desired speed while following the virtual object.

6. The system of claim 1, wherein accelerating includes:
generating an acceleration trajectory for the first vehicle based on the acceleration of the virtual vehicle;
generating commands to accelerate the first vehicle based on the acceleration trajectory; and
accelerating the first vehicle based on the generated commands.

7. The system of claim 1, further comprising terminating the virtual vehicle object in response to detecting an in-path vehicle in front of the first vehicle in the first lane.

8. A non-transitory computer readable storage medium having embodied thereon a program, the program being executable by a processor to perform a method for automatically accelerating an autonomous vehicle, the method comprising:
detecting that a first vehicle in a first lane of a road is traveling at a speed below a desired speed for the first vehicle;
detecting no real objects in front of the first vehicle in the first lane;
generating a virtual object having a position in front of the first vehicle in the first lane, the virtual object accelerating in the first lane at a first acceleration rate; and
accelerating the first vehicle at a second acceleration rate based at least in part on the position of the virtual position of the first virtual object as the virtual object accelerates in the first lane.

9. The non-transitory computer readable storage medium of claim 8, wherein the acceleration of the virtual object is tunable.

10. The non-transitory computer readable storage medium of claim 9, wherein the acceleration is tunable based on user input, user driving data, or other data.

11. The non-transitory computer readable storage medium of claim 9, wherein the acceleration is tunable based on the acceleration of the first vehicle, the speed difference between the first vehicle current speed and the desired speed,

12. The non-transitory computer readable storage medium of claim 8, wherein accelerating the first vehicle includes:
providing perception data for the generated virtual object to an adaptive cruise control system, the perception data including location and acceleration data; and
initiating control of the first vehicle by the adaptive cruise control system to accelerate towards the desired speed while following the virtual object.

13. The non-transitory computer readable storage medium of claim 8, wherein accelerating includes:
generating an acceleration trajectory for the first vehicle based on the acceleration of the virtual vehicle;
generating commands to accelerate the first vehicle based on the acceleration trajectory; and
accelerating the first vehicle based on the generated commands.

14. The non-transitory computer readable storage medium of claim 8, further comprising terminating the virtual vehicle object in response to detecting an in-path vehicle in front of the first vehicle in the first lane.

15. A method for automatically accelerating an autonomous vehicle, comprising:
detecting, by a data processing system, that a first vehicle in a first lane of a road is traveling at a speed below a desired speed for the first vehicle;
detecting, a data processing system, no real objects in front of the first vehicle in the first lane;
generating, a data processing system, a virtual object having a position in front of the first vehicle in the first lane, the virtual object accelerating in the first lane at a first acceleration rate; and
accelerating the first vehicle at a second acceleration rate based at least in part on the position of the virtual position of the first virtual object as the virtual object accelerates in the first lane.

16. The method of claim 15, wherein the acceleration of the virtual object is tunable.

17. The method of claim 16, wherein the acceleration is tunable based on user input, user driving data, or other data.

18. The method of claim 16, wherein the acceleration is tunable based on the acceleration of the first vehicle, the speed difference between the first vehicle current speed and the desired speed,

19. The method of claim 15, wherein accelerating the first vehicle includes:
providing perception data for the generated virtual object to an adaptive cruise control system, the perception data including location and acceleration data; and
initiating control of the first vehicle by the adaptive cruise control system to accelerate towards the desired speed while following the virtual object.

20. The method of claim 15, wherein accelerating includes:
generating an acceleration trajectory for the first vehicle based on the acceleration of the virtual vehicle;
generating commands to accelerate the first vehicle based on the acceleration trajectory; and
accelerating the first vehicle based on the generated commands.
